(19) United States
(12) Patent Application Publication
(10) Pub. No.: US 2022/0176511 A1
(43) Pub. Date: Jun. 9, 2022

(54) PROTECTION DEVICE FOR A POWER TOOL, AND SYSTEM WHICH COMPRISES A PROTECTION DEVICE AND A POWER TOOL

(71) Applicant: Hilti Aktiengesellschaft, Schaan (LI)

(72) Inventors: Ralf GREITMANN, Kaufering (DE); Roland MEUER, Ettringen (DE); Thomas REICHENBERGER, Untermuehlhausen (DE); Michael HEGER, Augsburg (DE)

(21) Appl. No.: 17/601,826

(22) PCT Filed: Dec. 17, 2019
(86) PCT No.: PCT/EP2019/085668

§ 371 Date: Oct. 6, 2021

(30) Foreign Application Priority Data
Apr. 29, 2019 (EP) 19171534.1

(51) Int. Cl. B24B 23/00; B24B 23/02

(52) U.S. Cl. CPC B24B 23/005; B24B 23/028

(57) ABSTRACT

A protection device for a power tool is provided. The power tool can be, in particular, a hand-held battery-operated power tool, such as a cut-off grinder. The power tool preferably has main components in a main region, such as a motor, transmission and rechargeable batteries, which are protected effectively from mechanical damage, e.g. when dropped, by the protection device. Moreover, the protection device prevents the transmission of vibrations in the power tool to the user. In a second aspect, the invention relates to a system which comprises a protection device and a power tool.

### BACKGROUND

The present invention relates to a protection device for a power tool. The power tool can be, in particular, a hand-held battery-operated power tool, such as a cut-off grinder.

### SUMMARY OF THE INVENTION

The prior art includes cut-off grinders for cutting disks with a diameter of 300 mm and above, which are usually operated with a corded power supply or an internal combustion engine. In this case, power consumptions of more than 2.0 kW are common, for example. The internal combustion engines are usually two-stroke engines. The disadvantage with these conventional cut-off grinders that are known from the prior art and operated with a power supply or an internal combustion engine as a power source is the fact that they either have a cable for transmitting the electric power, which can represent a safety risk during the operation of the cut-off grinder. Admittedly, the use of an internal combustion engine as a power source enables high power levels of the kind that are required for working with large cutting disks to be achieved. However, internal combustion engines have the usual disadvantages that, for example, a fuel must be available and taken along at all times or that there can be noise and pollutant emissions.

Battery-operated cut-off grinders have therefore been developed in order to minimize the use of cabling and the associated safety risk and to be able to dispense with the provision of internal combustion engines. These battery-operated cut-off grinders operate with a power consumption of 1.5 kW, for example, and with cutting disks that have a diameter of 230 mm. However, no convincing concepts for vibration damping have been presented in connection with these new battery-operated cut-off grinders, and therefore the vibrations which occur during the operation of the cut-off grinder in the case of the hitherto known solutions are transmitted substantially undamped to the user. It is known that such undamped transmission of vibrations can damage particularly the joints of the user. In particular, known battery-operated cut-off grinders do not have any vibration damping, and therefore there is no reduction of the effects of vibration on the user.

Another disadvantage of the known battery-operated cut-off grinders is that they are considerably heavier than mains-powered or petrol-powered power tools, i.e. they have a higher weight. Moreover, power supply based on rechargeable batteries makes it necessary to provide an enlarged installation space for the rechargeable batteries, making the power tools unwieldy and difficult to operate. This is particularly unpleasant in the case of prolonged use. In order to protect a battery-operated power tool or the rechargeable batteries thereof from damage due to dropping, they are often provided with a robust construction. However, this can disadvantageously lead to a further increase in the weight of a battery-operated power tool.

It is an object of the present invention to overcome the above-described disadvantages of battery-operated power tools, e.g. cut-off grinders, and to make available a protection device for power tools, especially hand-held, battery-operated cut-off grinders, by means of which it is possible to prevent transmission of vibrations in the power tool to the user in order, in particular, to spare the joints of the user and to avoid long-term adverse effects on the user. Moreover, it would be desirable if it were possible to enhance the robustness of the power tool with the protection device provided in order to avoid mechanical damage to the power tool, e.g. when dropped. Another alternate or additional concern of the invention is, by means of the invention, to enable a construction of the power tool which is as far as possible optimized in terms of weight in order to be able to construct a manageable, compact and as light as possible power tool which can be used comfortably, even for prolonged periods.

The present invention provides a protection device for a power tool, wherein the power tool comprises a motor, a transmission and at least one rechargeable battery as main components. The protection device is characterized in that the power tool can be inserted into the protection device in such a way that the protection device surrounds the power tool, wherein a connection between the power tool and the protection device can be established by a number of contact points, wherein damper elements are provided at these contact points between the power tool and the protection device.

In other words, the power tool can be inserted into the protection device in such a way that the protection device advantageously surrounds the main components of the power tool and protects them effectively from external mechanical influences, such as falls or impacts. A connection between the power tool and the protection device can preferably be established by the provision of contact points, wherein damper elements are arranged at these contact points between the power tool and the protection device. The damper elements preferably ensure vibrational decoupling between the power tool and the protection device. In other words, the damper elements are designed to vibrationally decouple the power tool and the protection device.

Although the description of the protection device refers to the power tool, the protection device is not characterized by features of the power tool but, in particular, is suitable for use with a power tool. Despite the reference to the power tool, it is therefore, in particular, not the case that the features of the protection device are worded unclearly for a person skilled in the art. A person skilled in the art knows, for example, the construction of the rear region of a, preferably battery-operated, power tool and what dimensions the rear region of such a power tool may have. The feature according to which the protection device is designed in such a way that it can accommodate the rear part of a power tool is therefore interpreted as illustrated, for example, in the figures.

In particular, the protection device comprises a frame-type device which is preferably formed by the two grips and the protection frame. Said components of the frame-type device preferably surround a hollow interior space, which is designed to accommodate the rear part of a power tool. It is in this rear part of the power tool that the main components of the power tool are preferably arranged, and they can therefore be surrounded by the frame-type device and protected by the latter. The rear region of the power tool is preferably also referred to as the main region of the power tool. The protection device advantageously allows a surprisingly light and, at the same time, robust construction of the power tool as well as low-vibration work with a power tool which is connected to a protection device. In particular, the present invention relates to a protection device for a battery-operated power tool, preferably a protection device for a battery-operated cut-off grinder for cutting disks with a diameter of 300 mm or above.

Apart from the grips and the protection frame, the protection device preferably comprises a number of damper elements. The provision of the damper elements advantageously leads to the ability to vibrationally decouple the power tool and the protection device from one another. This advantageously prevents oscillations and vibrations in the power tool from being transmitted to the protection device, in particular the handgrips. Since the power tool is preferably held or guided on components of the protection device, such as the grips, during its use, the user of the power tool is effectively protected from the vibrations by the protection device because it is possible, via the invention, to prevent vibrations emanating from the power tool from being transmitted to the user or the user's joints. On the one hand, the invention thus reduces the vibrational stress on the user of the power tool and, on the other hand, the protection device protects the tool effectively from damage, e.g. in the case of a drop or when objects fall on the power tool. In particular, the robustness of the power tool is significantly increased. Through the provision of the protection device, it is advantageously also possible to reduce the outlay on protection which must be made on the power tool itself. It is thereby possible to make available a particularly light, compact and manageable power tool with which the user can work for a long time comfortably and without trouble and complication. Springs, rubber dampers or combined elements can be used as damper elements, for example. In particular, the damper elements employed are suitable for reducing vibrational stress on the user.

According to the invention, it is preferred that the protection device comprise a first grip and a second grip as well as a protection frame and damper elements. The protection device is preferably designed to vibrationally decouple the main components of the power tool from the first and the second grip. The first grip and the second grip are preferably designed as holding or handgrips, thus enabling the user to hold and/or guide the power tool via the grips. According to the invention, it is preferred that the power tool comprise essentially two regions. The work-performing means can be provided in a front region of the power tool. This can be a cutting disk, for example, if the power tool is a cut-off grinder. In other words, the power tool can comprise not only the main components but also a work-performing means, which preferably represents a cutting disk for a cut-off grinder. The work-performing means is preferably protected by a blade guard in order to prevent chips or particles being thrown in the direction of the user by the work-performing means.

The main components, such as the motor, the transmission and the battery, can be provided in a rear region of the power tool. According to the invention, this region is preferably also referred to as the main region of the power tool. In particular, the protection device preferably surrounds this rear region of the power tool. According to the invention, it is preferred that the rear region of the power tool have a substantially cuboidal, three-dimensional shape. Two batteries, which serve as a power source for the power tool, can be provided in a lower region of this cuboid, for example. The transmission and the motor of the power tool can be arranged above this, for example.

In order to allow the simultaneously light and robust construction of the power tool and low-vibration working with the power tool, it is preferred according to the invention that the mass of the power tool should be decoupled from the handgrips of the protection device. It is thereby advantageously possible to optimize the position of the center of gravity within the power tool such that the center of gravity is substantially central within the power tool. The operation and guidance of the power tool can thereby be made significantly easier for the user.

The decoupling of the mass of the power tool from the handgrips of the protection device is preferably accomplished using the damper elements, which are situated at the contact points between the protection device and the power tool. The decoupling of the power tool mass from the handgrips is preferably achieved, in particular, by decoupling the main components of the power tool from the handgrips. In addition, the protection device comprises a protection frame to protect the rechargeable batteries and the power tool, said frame preferably forming a fixed unit with the grips. It is particularly preferred according to the invention that the frame form a preferably encircling rigid unit with the first and the second grip as a protection device which can be decoupled vibrationally from the power tool.

The protection device preferably has a plurality of damper elements. According to the invention, it is preferred that the protection device comprise two to twelve damper elements and, particularly preferably, three to five damper elements. The damper elements can be used individually and in pairs. If five damper elements are provided, three decoupling regions can be formed between the protection device and the power tool, for example. For example, two damper elements can form a first decoupling region, which is preferably arranged in the transitional region between the first grip and the power tool. In this first decoupling region, two damper elements form a connection between the protection device or the first grip and the power tool, for example, wherein the damper elements are designed to decouple the protection device and the power tool from one another in such a way that, in comparison with conventional power tools and protection devices, considerably less vibration is transmitted from the power tool to the protection device and, via the handgrips, to the user. Such a reduction in the transmission of vibrations or oscillations is referred to according to the invention as vibrational or oscillatory decoupling of the protection device and the power tool. In other words, it is preferred according to the invention that the damper elements form decoupling regions, wherein the decoupling regions each comprise one damper element or two damper elements.

There can preferably be a second decoupling region in a connecting region between the protection device and a lower side of the main region of the power tool. The second decoupling region preferably comprises one or two damper elements, which preferably effect oscillatory decoupling between the, preferably solid or compact, main region of the power tool and the protection device. There can be a third decoupling region in a rear region of the main region of the power tool. In a particularly preferred embodiment, the decoupling region comprises a damping element, wherein, in particular, the damping element connects the first grip and the protection frame to the power tool and decouples them vibrationally from one another.

It is preferred according to the invention that the power tool be a hand-held, battery-operated power tool, which, in particular, can be a cut-off grinder. In the context of the present invention, the term “power tool” includes, in particular, those power tools which drive a disk-shaped machining tool around an axis of rotation during the machining of a workpiece. Typical examples of such power tools are a cut-off grinder, an angle grinder and a circular saw. The cut-off grinder is preferably designed to operate with cutting disks which have a diameter of 300 mm or above as the work-performing means. Battery operation can be ensured, in particular, by the provision of at least one rechargeable battery, which is used within the power tool as a rechargeable power source. According to the invention, the at least one rechargeable battery (“Akkumulator” in German) is preferably also referred to as a battery (“Akku”, abbreviated form in German).

By means of the present invention, vibration damping for a hand-held, battery-operated cut-off grinder is advantageously provided, in which, in particular, the main components of the power tool, such as the motor, the transmission, the battery and the work-performing means, e.g. a cutting disk, are decoupled vibrationally from the grips of the protection device. In other words, the present invention prevents unwanted oscillations and vibrations from being transmitted from the main components of the power tool to the handgrips and hence to the user of the power tool in a particularly effective manner. The vibrations which arise during the operation of the power tool preferably arise at these main components.

The grips of the protection device preferably form handgrips, via which a user can pick up and operate the power tool. The protection device comprises a first grip and a second grip, wherein the first grip can preferably also be referred to as the rear grip and the second grip can preferably also be referred to as the front grip of the power tool. The front grip can, for example, form a frame which has a substantially elliptical or right-angled opening.

For reasons of weight, the grips preferably comprise plastic. It can also be preferred according to the invention that the grips be manufactured completely or partially of plastic. The encircling front handgrip of the protection device is preferably of substantially entirely or partially hollow design. In other words, the front encircling handgrip can comprise one or more cavities in its interior. It is thereby advantageously possible to further reduce the contribution of the grip to the total weight of the power tool. The rear grip of the protection device preferably contains a switching device by means of which the power tool can be switched on or off, for example. It is preferred according to the invention that the rear grip comprise two parts, for example, wherein it is possible, in particular, for the two individual parts of the rear grip to be of mutually corresponding design. For example, the rear grip can be of two-part design and/or be constructed in shell form. It has surprisingly been found that, by virtue of the invention, the handgrips of the protection device can be made particularly light, thus making it possible overall to provide a power tool with a surprisingly low weight.

The front grip is preferably passed around a housing of the power tool, thus ensuring that this second grip of the protection device effectively protects the housing and the internal components of the power tool that are arranged within the housing. In other words, it is preferred according to the invention that the second grip be of substantially annular design, wherein the annular structure of the second grip is designed to surround a transitional region between a front region and a rear region of the power tool. The internal components are therefore protected not only by the provision of the housing but also by the second handgrip of the protection device, which is preferably of frame-shaped design. It is thereby advantageously also possible to make the housing of the power tool lighter or with a lower weight, advantageously resulting in a further reduction in the total weight of the power tool to the provided. The second handgrip can preferably be connected to the protection frame of the protection device in an inner lower region.

According to the invention, the spatial direction “lower” is not an unclear concept for a person skilled in the art since it is intended to refer to the region below the power tool or the lower region of the power tool or of the protection device. If the power tool is placed on an underlying surface or the ground, for example, the lower region of the power tool faces the underlying surface or the ground. The power tool preferably also has an upper side, which lies opposite the lower side of the power tool and faces the user during the use of the power tool. The rear side of the power tool preferably also faces the user when the user is using the power tool, while the work-performing means of the power tool is mounted on the side of the power tool which faces away from the user during the operation of the power tool.

It is preferred according to the invention that the protection frame should have a double-L-shaped structure which is designed to surround a lower side of the power tool. The double-L-shaped structure can preferably be part of a U-section, which, in particular, may be of reinforced design. In side view, the protection frame preferably has an L shape, wherein the longer side of the letter “L” forms the lower side of the protection frame or protection device. The protection frame preferably comprises two L-shaped side parts, which are each connected by a connecting part in an upper, rear region and a front, lower region. These connecting parts are preferably also referred to as connecting sections. According to the invention, it is preferred that the connecting parts should in each case be of substantially orthogonal design with respect to the respective sides of the letter “L” which together form the preferably L-shaped side parts of the protection frame. Thus, the connecting section which connects the side parts to one another in the rear region of the protection frame may be referred to as the upper, rear connecting section, while the connecting section which is arranged between the front grip and the protection frame in the connecting region may be referred to as the front, lower connecting section. The protection frame thus preferably comprises two preferably L-shaped side parts, which are connected to one another by two connecting sections.

The shorter side of the letter “L” preferably forms the back or rear side of the protection frame. In the front region of the longer, lower side, the protection frame is preferably connected to the second grip of the protection device, wherein the second grip and the lower region of the protection frame are preferably arranged substantially orthogonally, i.e. perpendicularly to one another. The second grip and the shorter side of the preferably L-shaped protection frame are preferably formed substantially parallel to one another. In the upper region of the shorter side of the preferably L-shaped protection frame, the protection frame is preferably connected to the first grip of the protection device.

The first grip is preferably formed by a hoop, which connects the rear region of the protection frame to the housing of the power tool. According to the invention, it is preferred that the grips of the protection device, together with the protection frame, should form a stable external skeleton, which may preferably also be referred to as an outer skeleton for the power tool. The outer skeleton can advantageously be designed to receive the interior power tool via the damper elements. The rear grip of the protection device can be designed in such a way in a rear region that the rear grip extends in a hook shape around the upper, rear connecting section of the protection frame. It is thereby possible for a connection or fastening between the protection frame and the rear grip to be formed in this region of the protection device. According to the invention, it is preferred that a damping element be provided between the protection device and the power tool in this connecting region, wherein this damper element preferably forms the third decoupling region of the invention.

The power tool can preferably be carried by the rear grip, which is preferably of hoop-shaped design, when the power tool is to be transported from one location to another. As an alternative, it is also possible to use the upper region of the front grip. According to the invention, it is preferred that the first grip comprise operating elements for operating the power tool. In other words, it is also possible to provide operating elements for operating or controlling the power tool in the rear grip of the protection device.

According to the invention, it is very particularly preferred that the first grip, the second grip and the protection frame together form a frame-shaped device which surrounds the compact rear region of the power tool. The protection device preferably forms a frame-shaped device with which the power tool can be surrounded in order to protect it. The power tool is preferably arranged in the open interior region of the protection device. According to the invention, it is preferred that the components of the protection device have a clearance with respect to the power tool rear region to be protected. In other words, the protection device has just a few contact points with the power tool, and therefore transmission of oscillations and vibrations from the power tool to the protection device can take place only at these few contact points. At these contact points with the power tool, the protection device has damping elements, which prevent transmission of vibrations and oscillations, which occur during the operation of the power tool for example, to the protection device in a particularly effective manner. For example, fastening of the power tool to the protection device can be provided at three to five points for example, although it is also possible to provide more or fewer contact points. The power tool is preferably secured in the protection device with damping elements in the contact points between the components of the protection device and the power tool. According to the invention, the terms “damper element” and “damping element” are used as synonyms.

The protection frame can be secured with one or two damping elements on a lower side of the power tool, for example. On the upper side, the power tool can be secured with two further damper elements, for example, on the rear grip, which is preferably designed as a hoop-shaped holder. Another damping element can be provided in the connecting region between the protection frame and the rear grip of the protection device. By virtue of the provision of the damping elements at the contact points, the power tool can be decoupled vibrationally from the protection device, thus advantageously ensuring that no unwanted vibrations that may arise during work with the power tool are transmitted to the user and the user's joints. Moreover, the rear region of the power tool can be surrounded by the protection device in such a way that especially the main components of the power tool, such as the transmission, motor and batteries, are protected in the optimum way from mechanical damage in the event of a drop.

Apart from the damper elements, additional stop dampers can enhance robustness in the event of a drop. In other words, it is preferred according to the invention that the protection device should comprise stop dampers for enhancing the robustness of the power tool. In particular, the stop dampers can comprise a flexible material or be formed completely or partially from said material. The stop dampers are formed from rubber, for example. In particular, they can be accommodated at defined robust contact points between the power tool and the protection device. The stop dampers can be accommodated either in the protection device or in the power tool, for example. It can be advantageous here to mount them in the vicinity of the damper elements.

In a second aspect, the invention relates to a system which comprises a protection device and a power tool, wherein the power tool comprises a motor, a transmission and at least one rechargeable battery as main components. The system is characterized in that the power tool can be inserted into the protection device in such a way that the protection device surrounds the power tool, wherein a connection between the power tool and the protection device can be established by a number of contact points, wherein damper elements are provided at these contact points between the power tool and the protection device. The definitions, technical effects and advantages stated for the protection device apply analogously to the system.

### BRIEF DESCRIPTION OF THE DRAWINGS

In the figures, identical components and components of identical type are designated by identical reference signs. In the figures:

FIG. 1 shows an illustration of some components of a preferred embodiment of the invention

FIG. 2 shows an illustration of the components of a preferred embodiment of the protection device with damping elements composed of a flexible material, e.g. rubber.

FIG. 3 shows an illustration of a preferred embodiment of the protection device with damping elements which comprise springs, e.g. cylindrical compression springs.

FIG. 4 shows an illustration of a preferred embodiment of the protection device with stop dampers

FIG. 5 shows an illustration of a preferred embodiment of the system

FIG. 6 shows an illustration of the decoupling regions of a preferred embodiment of the invention

FIG. 7 shows an illustration of a preferred embodiment of the protection device with specifically designated damping elements

### DETAILED DESCRIPTION

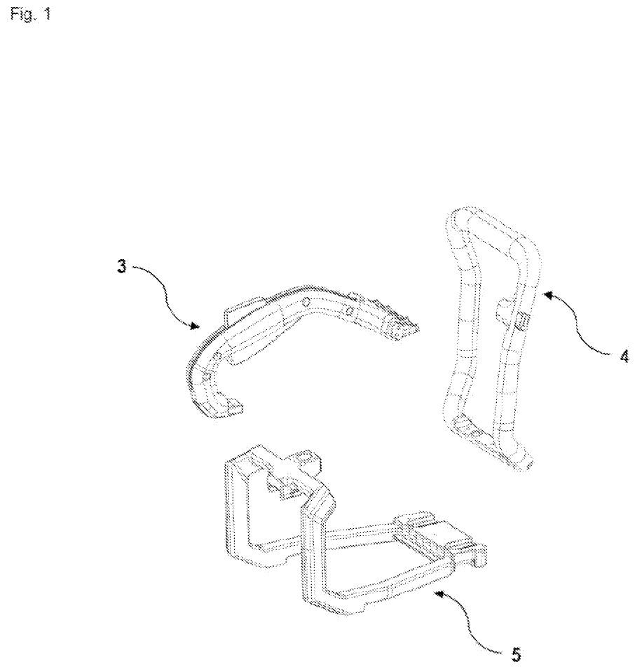

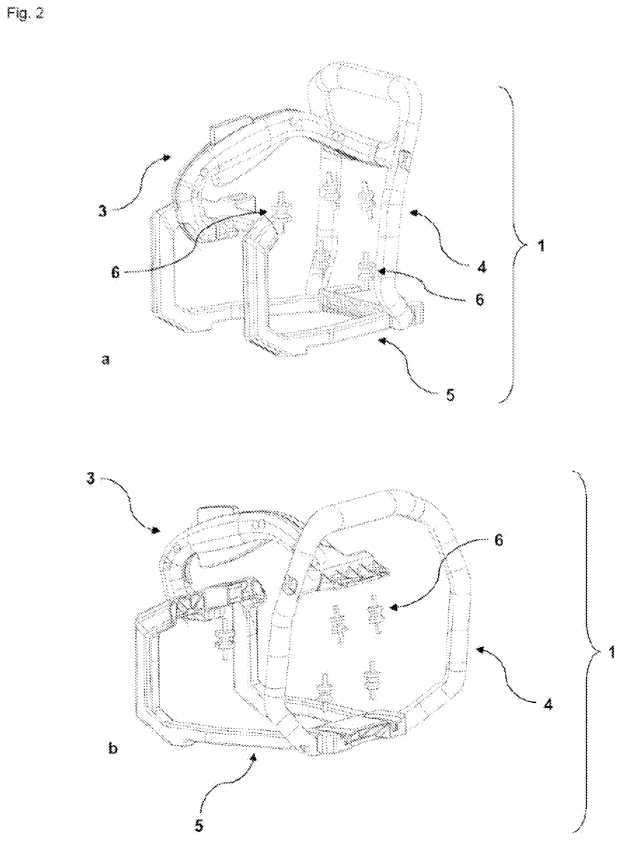

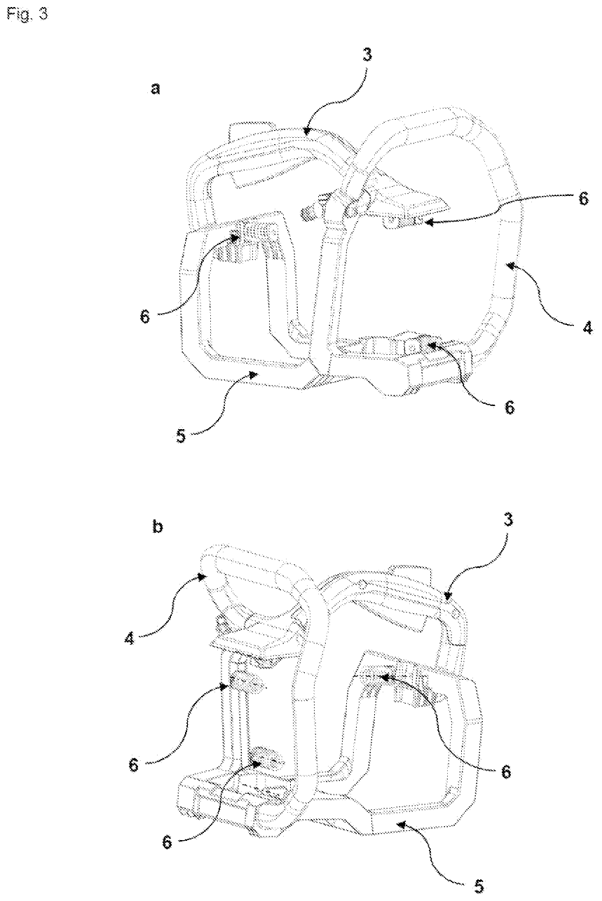

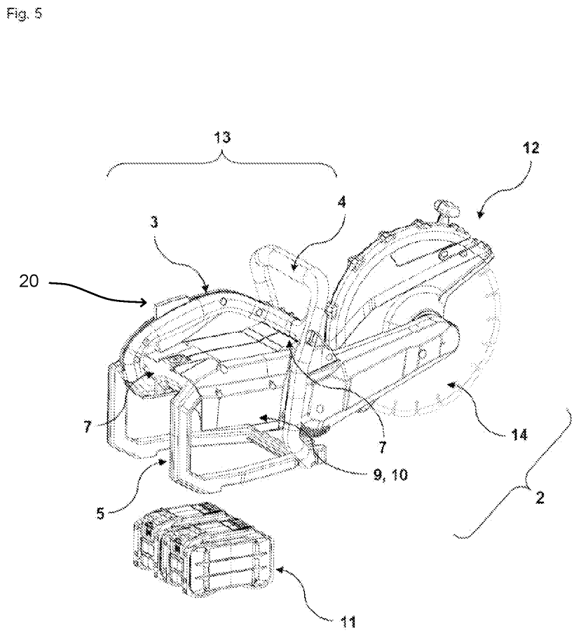

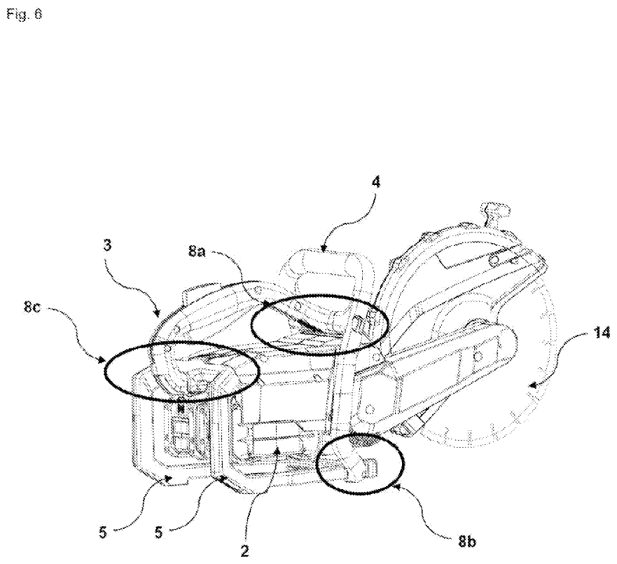

FIG. 1 shows some components of a preferred embodiment of the protection device (1) (see, e.g., FIG. 2). In particular, FIG. 1 shows the first grip (3), which, according to the invention, is preferably also referred to as a rear grip. The first grip (3) preferably forms an upper side of the protection device (1), via which the power tool (2), which is illustrated in FIGS. 5 and 6, can be carried. As an alternative, the power tool (2) can be carried using the second grip (4) of the protection device (1), which is preferably also referred to as the front grip of the protection device (1). Together with a protection frame (5), the grips (3, 4) form a frame-shaped device, which can surround the rear part (13) of a power tool (2), wherein the power tool (2) and the protection device (1) are connected to one another. In particular, the frame-shaped device defines an interior space into which the rear part (13) of the power tool (2) can be inserted. Most of the frame-shaped device has a clearance with respect to the power tool (2), with the result that there is contact between the power tool (2) and the protection device (1) only at a few points. At these contact points (7), damper elements (6) (see, e.g. FIGS. 2 and 3) are provided, which are preferably designed to establish a connection between the power tool (2) and the protection device (1). In particular, however, the damper elements (6) effect decoupling between the power tool (2) and the grips (3, 4) and the protection frame (5) of the protection device (1). In particular, this decoupling ensures that only a little vibration is transmitted from the power tool (2) to a user. While carrying out work, the user preferably grips the power tool (2) by the grips (3, 4) of the protection device (1), and therefore vibrational decoupling between the power tool (2) and the grips (3, 4) of the protection device (1) effectively prevents the joints, in particular, of the user from being damaged by vibrations during prolonged use of the power tool (2). Moreover, the protection device (1) ensures effective protection of the power tool (2), e.g. in the event of drops or other mechanical damage.

The frame-shaped structure surrounds, in particular, the rear part (13) of the power tool (2), wherein the main components (9, 10, 11) of the power tool (2) are situated particularly in the rear region (13) of the power tool (2). These are, in particular, the motor (9), the transmission (10) and the at least one rechargeable battery (11) of the power tool (2) (see, e.g., FIG. 5). The power tool (2) is preferably a battery-operated cut-off grinder, which, in particular, is operated with cutting disks that have a diameter of 300 mm or above. By virtue of the vibrational decoupling of the power tool (2) and the protection device (1), a particularly simple, compact and robust construction of the power tool (2) can advantageously be made possible, wherein the power tool (2) can nevertheless have a low total weight and can be operated with minimal transmission of hand-arm vibrations to the user. In particular, the invention allows splitting of the functions of the individual components of the protection device (1) and of the power tool (2), thus enabling the system components, such as the rechargeable battery (11), the motor (9), the transmission (10), the cutting disk (14), the damper elements (6) and/or the grips (3, 4) to be optimized for their respective tasks. Another advantage of the invention consists in that simple assembly of the system can be made possible by the provision of a functional unit (13) of the power tool (2) with the main components (9, 10, 11), on the one hand, and the provision of the preferably decoupled protection device (1) with integrated handgrips (3, 4), on the other hand.

In the oblique side view in FIG. 1, it is possible, in particular, to discern the double-L-shaped structure of the protection frame (5). By virtue of this structure, the protection frame (5) is configured to surround a lower side of the power tool (2) and to accommodate the main components (9, 10, 11) of the power tool (2). The longer side of the preferably L-shaped protection frame (5) preferably forms the lower side of the protection device (1), while the shorter side of the protection frame (5) forms the rear or back side thereof.

FIG. 2 shows how the components (3, 4, 5, 6) of the protection device (1) can be joined together in order to form a preferred embodiment of the protection device (1). In particular, it illustrates how the protection frame (5) can be connected to the handgrips (3, 4), thus forming the frame-shaped device with the interior space to accommodate the rear region (13) of the power tool (2). Damper elements (6) and the possible arrangement thereof in the frame-shaped structure are furthermore shown in FIG. 2. The damper elements (6) are preferably situated at those points of the frame-shaped structure at which there is contact between the protection device (1) and the power tool (2). According to the invention, these points are preferably referred to as contact points (7). The damper elements (6) or contact points (7) preferably form decoupling regions (8a, 8b, 8c) (see, e.g., FIG. 6), at which the vibrational decoupling between the protection device (1) and the power tool (2) occurs. FIGS. 2a and 2b show different views of a preferred embodiment of the protection device (1), wherein the damping elements (6) illustrated in FIGS. 2a and 2b are formed, in particular, from a flexible material. In particular, these damping elements (6) can preferably comprise rubber.

FIG. 3 shows a preferred embodiment of the protection device (1), which comprises springs as damping elements (6). The springs can be designed as cylindrical compression springs, for example. FIGS. 3a and 3b show different views of a preferred embodiment of the protection device (1).

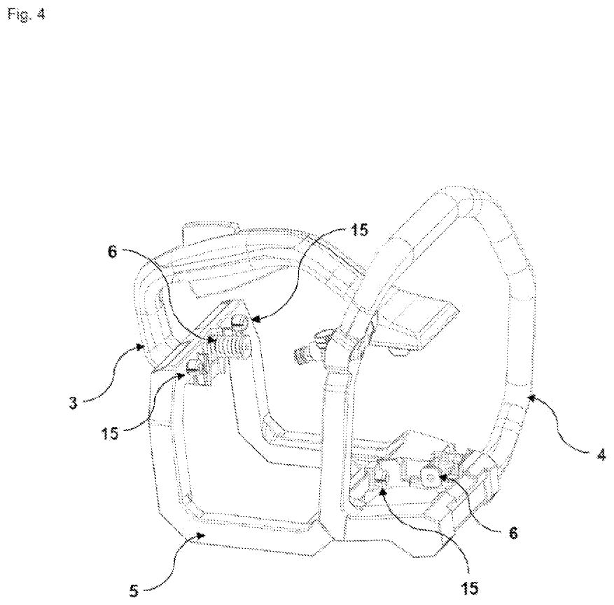

FIG. 4 shows a preferred embodiment of the protection device (1) with stop dampers (15). In particular, FIG. 4 shows possible mounting locations of the stop dampers (15) in the context of the protection device (1). The stop dampers (15) can be arranged in a transitional region between the rear grip (3) and the protection frame (5), for example. Moreover, the stop dampers (15) can also be arranged in a transitional region between the front grip (4) and the protection frame (5).

FIG. 5 shows a preferred embodiment of the system comprising the protection device (1) and the power tool (2). In particular, FIG. 5 shows how the protection device (1) and the power tool (2) can be arranged relative to one another. The protection device (1) preferably accommodates the rear part (13) of the power tool (2) with the main components, such as the motor (9), the transmission (10) and the rechargeable batteries (11). In the exemplary embodiment of the invention which is shown in FIG. 5, the rechargeable batteries (11) of the power tool (2) are illustrated in the uninstalled state.

The power tool (2) illustrated in FIG. 5 has two rechargeable batteries (11), for example. However, it is also possible for just one rechargeable battery (11) or more than two rechargeable batteries (11) to be provided in the power tool (2). Adjacent to the rear region (13), the power tool (2) also has a front region (12). In this front region (12) of the power tool (2), a work-performing means (14) can be provided, which, in the case where the power tool (2) is a cut-off grinder, is preferably a cutting disk. In the case of the present invention, the diameter of the cutting disk (14) can be 300 mm or above. Although the cutting disk (14) is not illustrated in FIG. 5, it does show a blade guard, which is a conventional means of preventing particles flying off the cutting disk (14) in the direction of the user of the power tool (2). An operating element such as a button is shown schematically as 20.

The position or arrangement of the decoupling regions (8a, 8b, 8c) of the present invention is illustrated particularly in FIG. 6. A first decoupling region (8a) can preferably be situated in the transitional region between the first handgrip (3) and the power tool (2). This first decoupling region (8a) can preferably comprise two damper elements (6). A second decoupling region (8b) is preferably formed in a transitional region between the protection frame (5) and the second handgrip (4) of the protection device (1), preferably on the lower side of the frame-shaped device. The second decoupling region (8b) also preferably comprises two damper elements (6). The third decoupling region (8c) preferably comprises one damper element (6) and is preferably situated in a transitional region between the first handgrip (3) and the upper part of the protection frame (5).

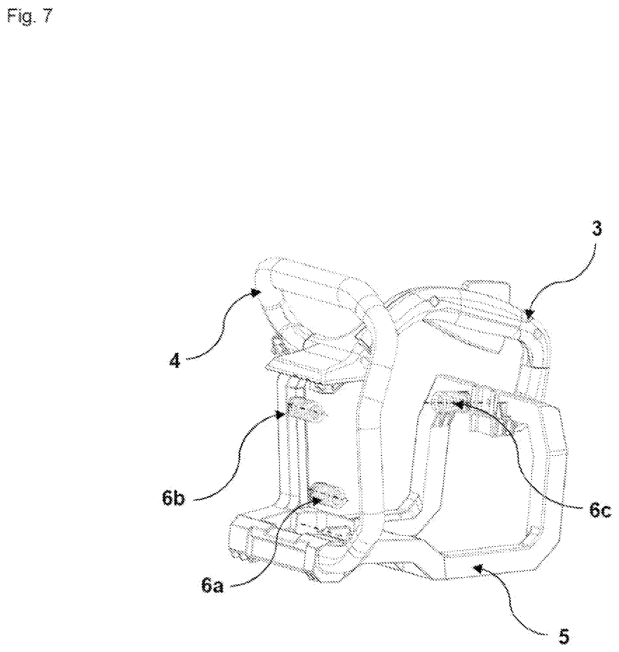

FIG. 7 shows a preferred embodiment of the protection device (1) with specifically designated damping elements (6). In this case, it is possible, in particular, for individual damping elements (6a, 6b) to be arranged transversely to a working direction of the power tool (2). In this case, an upper damping element (6b) is preferably arranged above a center of gravity of the power tool (2), while a lower damping element (6a) is preferably arranged below a center of gravity of the power tool (2). By virtue of this preferred arrangement of the damping elements (6a and 6b), the power tool (2) can be of particularly stable configuration. The damping element (6c) is preferably arranged in a rear region of the power tool (2), in particular in the center of the protection device (1). The damping element (6c) is preferably arranged in a working direction of the power tool (2), thereby making it possible to achieve particularly good vibration damping in the working direction.

According to the invention, it is particularly preferred that the power tool (2) have at least one rechargeable battery (11) for supplying the power tool (2) with electric power. To this extent, the protection device (1) can preferably also be referred to as a device (1) for protecting a rechargeable battery (11) in a power tool (2). In this case, the protection device (1) can surround the power tool (2) to protect the battery (11) and can be situated on the outside of the power tool (2). In addition to the previously mentioned damping elements (6), the power tool (2) can comprise further damping elements, which can comprise a flexible material, preferably rubber. These additional damping elements on the power tool (2) are preferably designed to additionally protect the protection device (1) and/or the power tool (2) or the battery (11) thereof in the event of drops. According to the invention, it is preferred that the protection device (1) should comprise substantially three components, in particular the first handgrip (3), the second handgrip (4) and the protection frame (5). These components (3, 4, 5) are preferably connected to one another in such a way that they are in contact in three regions and form “decoupling regions” (8a, 8b, 8c). In particular, the components (3, 4, 5) of the protection device (1) form a stable unit in order to protect the rechargeable battery (11) of the power tool (2). In particular, the motor (9) of the power tool (2) can preferably be an electric motor, which is supplied with electric power by the at least one battery (11) of the power tool (2).

### LIST OF REFERENCE SIGNS

1 protection device
2 power tool
3 first grip/rear grip
4 second grip/front grip
5 protection frame
6 damper elements
7 contact points
8 decoupling regions
9 motor of the power tool
10 transmission of the power tool
11 rechargeable batteries of the power tool
12 front part of the power tool
13 rear part of the power tool
14 work-performing means, e.g. cutting disk
15 stop dampers
20 operating element

1-9. (canceled)

10: A protection device for a power tool having a motor, a transmission and at least one rechargeable battery as main components, the power tool insertable into the protection device in such a way that the protection device surrounds the power tool, the protection device comprising:
a plurality of contacts points configured to establish a connection between the power tool and the protection device; and
damper elements provided at the contact points and configured to be between the power tool and the protection device.

11: The protection device as recited in claim 10 wherein a number of the damper elements is two to ten.

12: The protection device as recited in claim 11 wherein the number of the damper elements is three to five.

13: The protection device as recited in claim 10 wherein the damper elements define decoupling regions each having one damper element or two damper elements.

14: The protection device as recited in claim 10 further comprising a first grip, a second grip and a protection frame.

15: The protection device as recited in claim 14 wherein the protection frame has a double-L-shaped structure configured to surround a lower side of the power tool.

16: The protection device as recited in claim 14 wherein the first grip includes at least one operating element for operating the power tool.

17: The protection device as recited in claim 14 wherein the second grip has an annular structure configured to surround a transitional region between a front region and a rear region of the power tool.

18: The protection device as recited in claim 10 further comprising stop dampers.

19: A system comprising the protection device as recited in claim 10 and the power tool, the power tool being inserted into the protection device so that the plurality of contacts points establish the connection between the power tool and the protection device and the damper elements provide the contact points between the power tool and the protection device.
